(19) United States
(12) Patent Application Publication
(10) Pub. No.: US 2009/0033944 A1
(43) Pub. Date: Feb. 5, 2009

(54) Coded polarization-dependent interferometry

(76) Inventor: Hansjoerg Haisch, Altdorf (DE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 10/527,898

(22) PCT Filed: Sep. 13, 2002
(86) PCT No.: PCT/EP02/10285

§ 371 Date: Sep. 28, 2006

(51) Int. Cl. G01B 9/02

(52) U.S. Cl. 356/491

(57) ABSTRACT

An apparatus and a method of polarization dependent analyzation of an optical signal transmitted through a DUT includes splitting the optical signal into a first signal part having an initial first polarization and a second signal part having an initial second polarization, coding the first signal part using a first code and coding the second signal part using a second code, providing the coded signal parts to the DUT, detecting a DUT-signal coming from the DUT in response to the coded signal parts, and determining a first part of the DUT-signal corresponding to the first signal part by means of the first code and determining a second part of the DUT-signal corresponding to the second signal part by means of the second code.

### BACKGROUND OF THE INVENTION

The present invention relates to analyzing an optical signal transmitted through a device undertest (DUT), in particular to analyzing an optical signal transmitted through a DUT located in a measurement arm of an interferometric measurement setup.

### SUMMARY OF THE INVENTION

It is an object of the invention to provide improved analyzing an optical signal transmitted through a DUT. The object is solved by the independent claims.

When analyzing an optical signal transmitted through a DUT it can be advantageous to resolve polarization dependent information about polarization dependent properties of the DUT. Although this information is contained in the resulting signal, so far it requires repeated measurements to allocate this information to certain polarizations since there is only one signal leaving the DUT. An advantage of an embodiment of the present invention is the possibility of polarization dependent analyzing such an optical signal coming from the DUT.

Although signal parts having a certain polarization are superimposed it is possible to unambiguously separate the information in each signal part allocated to a certain polarization due to the present invention. This is made possible by making each signal part unique. Preferably, this can be done by coding each signal part. According to the present invention coding can be any type of coding as long as it is possible to identify each signal part by the used way of coding. E.g. coding could be done by any unambiguous coding scheme as known in the art, such as e.g. by modulating the signal (preferably with a pilot tone at a special frequency), and/or by applying a special code to the signal, etc.

For the purposes of the present invention it is not necessary to provide each signal with a coding, i.e. it is possible to let at least one of the signals uncoded.

The signals are preferably coded by intensity modulation of the signals, more preferably by using sinusoidal signals or binary codes.

The demodulation of the signal can be done by multiplying the signal with a corresponding sinusoidal signal of dedicated frequency or by multiplying the signal with each code. Due to the preferred orthogonality of the frequencies/codes it is then possible to allocate the thereby resolved information to a certain polarization.

In a first embodiment of the present invention the light emitted from a light source is split into at least two different light paths. Light in each arm is now coded. Afterwards the light is sent through at least two polarizers. Thus each polarization gets assigned a unique pilot tone frequency or code. At the output of the polarizer the light is combined again and sent through the DUT. A photo detector detects light leaving the DUT.

It is preferred and advantageous to modulate the light by orthogonal signals. For the case of using a pilot tone it is sufficient to modulate the signal by at least two different pilot frequencies. By using codes the codes are preferably orthogonal codes. This is preferred to resolve the information contained in the resulting signal and to avoid interference between the coded parts.

Due to the preferred embodiment of the invention it is possible to measure at least two polarizations simultaneously.

In a second embodiment of the present invention the DUT is located in a measurement arm of an interferometric measurement setup. It is possible to perform such interferometric measurements with an optical signal tuned in frequency or wavelength provided by a tunable laser source (TLS). Due to a preferred embodiment of the invention it is possible to make single sweep measurements in such setups and still gaining the polarization dependent information about the DUT.

Possible application fields of embodiments of the present invention are all measurement setups for measuring an optical property of a device under test using a TLS.

Other preferred embodiments are shown by the dependent claims.

It is clear that the invention can be partly embodied or supported by one or more suitable software programs, which can be stored on or otherwise provided by any kind of data carrier, and which might be executed in or by any suitable data processing unit.

### BRIEF DESCRIPTION OF THE DRAWINGS

Other objects and many of the attendant advantages of the present invention will be readily appreciated and become better understood by reference to the following detailed description when considering in connection with the accompanied drawings. The components in the drawings are not necessarily to scale, emphasis instead being placed upon clearly illustrating the principles of the present invention. Features that are substantially or functionally equal or similar will be referred to with the same reference sign(s).

FIGS. 1, 2 and 3 show schematic illustrations of embodiments of the present invention.

### DETAILED DESCRIPTION OF PREFERRED EMBODIMENTS OF THE INVENTION

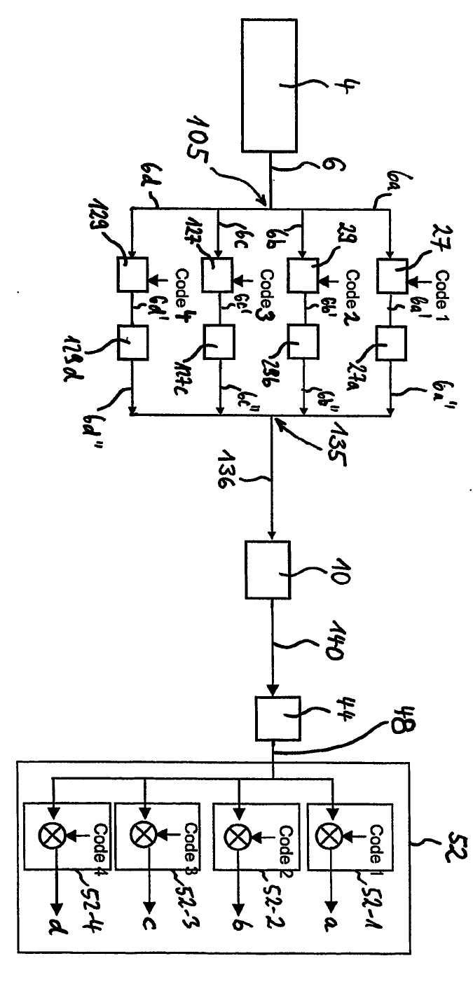

Referring now in greater detail to the drawings, FIG. 1 shows a schematic illustration of a first embodiment of the present invention. According to this embodiment an optical signal 6 of a TLS 4 is provided to a first coupler 105. The first coupler 105 has 4 output ports and splits the optical signal 6 into 4 parts 6a, 6b, 6c and 6d. Each signal part 6a, 6b, 6c and 6d is modulated by modulators 27, 29, 127 and 129, respectively. The first signal 6a is modulated using a first binary code code 1, the second signal part is modulated using a second binary code code 2, the third signal part is modulated using a third binary code code 3, and the fourth signal part is modulated using a fourth binary code code 4. Codes 1, 2, 3 and 4 are orthogonal to each other.

Subsequently each coded signal 6a′, 6b′, 6c′, 6d′ receives a defined polarization by polarization controllers 27a, 29b, 127c, 129d in the path of the coded signal 6a′, 6b′, 6c′, 6d′, respectively. The resulting polarized signals 6a″, 6b″, 6c″, 6d″ are then combined at a coupler 135 and provided as a superimposed signal 136 to a DUT 10. As modulators 27, 29, 127, 129 intensity modulators (e.g. LiNbO₃— based) can be used.

A signal 140 leaving the DUT 10 is then detected at a detector 44. A detector signal 48 containing coded signals for main polarizations and cross polarization is then provided to a correlation unit 52 containing four correlators 52-1, 52-2, 52-3 and 524. Each correlator 52-1, 52-2, 52-3 and 52-4 is demodulating the signal 48 by multiplying signal 48 with the codes code 1, code 2, code 3 and code 4, respectively. The results of the demodulation is then provided by the correlation unit 52 at output ports a, b, c and d of the correlators 52-1, 52-2, 52-3 and 52-4, respectively.

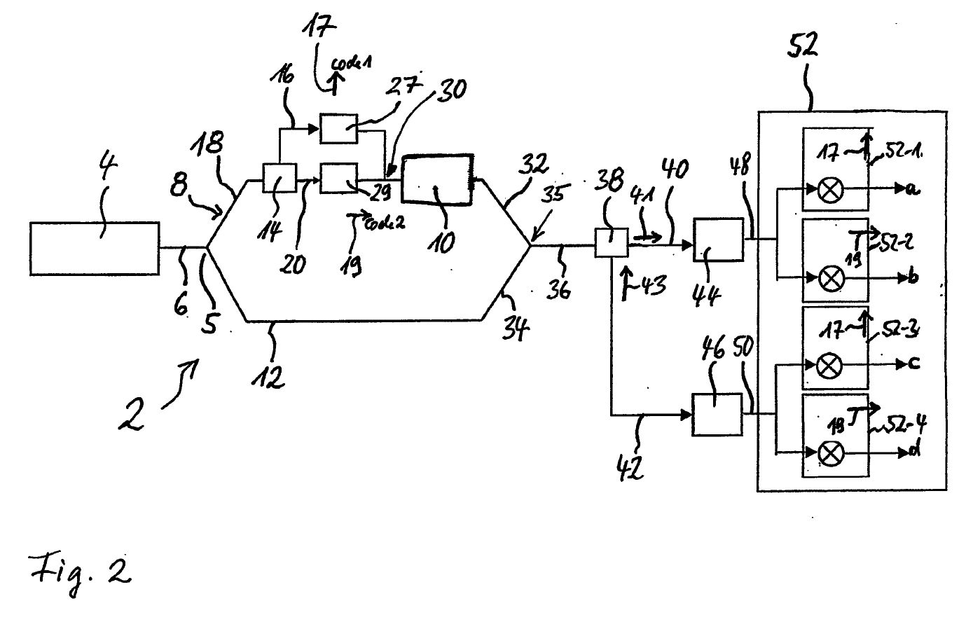

FIG. 2 shows a second embodiment of the present invention. It comprises an interferometer 2. Interferometer 2 comprises a TLS 4 providing an optical signal 6 to a first coupler 5 connected to a measurement arm 8, containing a DUT 10, and to a reference arm 12. Measurement arm 8 comprises a polarization beam splitter (PBS) 14 located before the DUT 10 splitting a measurement signal 18 into a first part 16 having a first polarization and a second part 20 having a second polarization orthogonal to the first polarization. The first part 16 is modulated by a modulator 27 with a first binary code (code 1) indicated by an arrow 17 and the second part is modulated by a modulator 29 with a second binary code (code 2) indicated by an arrow 19. Then at coupler 30 both parts are combined and provided to the DUT 10. As modulators 27,29 intensity modulators (e.g. LiNbO₃-based) are used here.

A signal 32 leaving the DUT 10 is then superimposed at a coupler 35 with a reference signal 34 of reference arm 12 to a superimposed signal 36. Subsequently the superimposed signal 36 is orthogonal split by a second PBS 38 into two orthogonal parts 40 and 42, the polarization of which is indicated by arrows 41 and 43, respectively. Parts 40 and 42 are provided to detectors 44 and 46. The signals 40 and 42 at each detector 44 and 46 contain both the information about the first polarization, e.g. the main polarization, and the second polarization, e.g. the cross polarization. The detector signals 48 and 50 are provided to a correlation unit 52 containing four correlators 52-1, 52-2, 52-3, and 524. Each correlator 52-1, 52-2, 52-3, and 524 is demodulating the signals 48 and 50, respectively, by multiplying each signal with the respective codes 17 or 19 as indicated by the circles containing crosses in FIG. 1. The result of the demodulation is then provided at output ports a-d of the correlators 52-1 to 52-4.

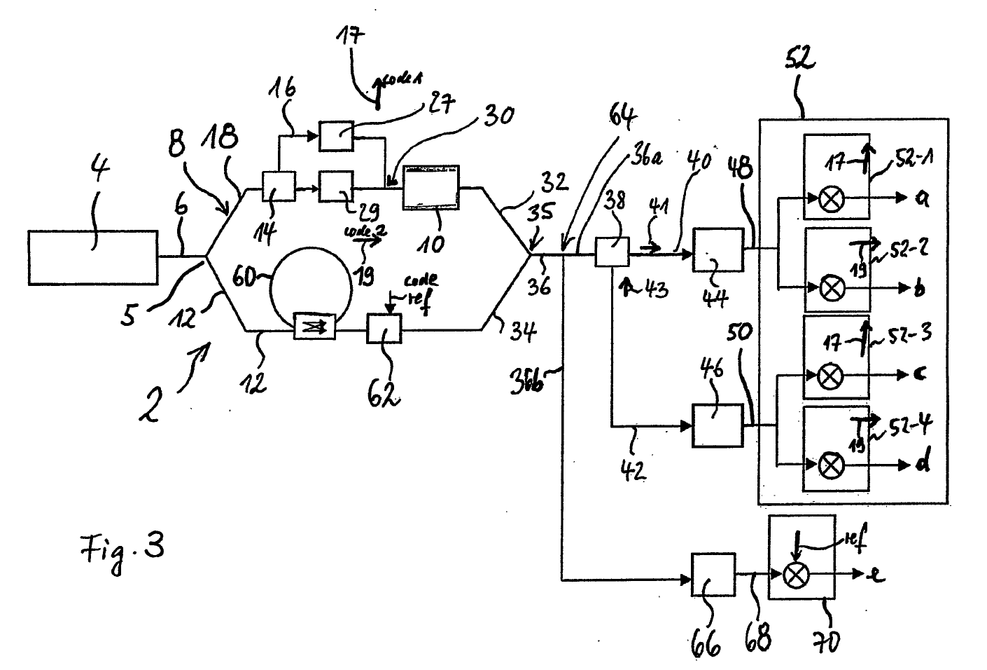

FIG. 3 shows a schematic illustration of another embodiment of the present invention. According to this embodiment, the reference arm 12 contains a delay line 60 providing a delay Δτ to the reference signal 34. For further details of the construction and the function of the delay line 60, it is referred to the parallel International patent application No. PCT/EP02/07726 of the applicant, the disclosure of which is incorporated herein by reference.

Furthermore, after the delay line 60, there is integrated in the reference arm 12 a third modulator 62, which is prepared to apply a reference code (code ref) to the reference signal 34. Contrary to the embodiment of FIG. 1, there is provided a coupler 64 to split the resulting superimposed signal 36 into a first part 36a and a second part 36b before being split by PBS 38. The second part 36b is then provided to a third detector 66 that provides a signal 68 to a fifth correlator 70. Correlator 70 identifies a part of the superimposed resulting signal 36 corresponding to the reference signal 34 by multiplying the second part 36b of the reference signal 36 with the reference code ref. In order to separate the signals it is required that code 1 and code 2 are orthogonal and code 1 and code ref are non-orthogonal and code 2 and code ref are also non-orthogonal.

Since delay line 60 provides a periodic delay Δτ to the reference signal 34, it is possible to analyze DUTs 10 with large delays.

The result of the interferometric analysis according to the embodiments illustrated in FIGS. 2 and 3 is provided for each state of polarization provided by PBS 14 at outputs a-d of the respective correlators 52-1 to 52-4. Accordingly, a wavelength reference signal is unambiguously provided at output e of correlator 70.

1. A method of polarization dependent analyzing an optical signal provided to a DUT, comprising the steps of:
using the optical signal as a measurement signal of an interferometer,
splitting the optical signal at least into a first signal part having an initial first polarization and a second signal part having an initial second polarization,
coding the first signal part using a first code and coding the second signal part using a second code,
providing the coded signal parts to the DUT,
superimposing a DUT-signal coming from the DUT in response to the coded signal parts with a reference signal of the interferometer to provide a resulting superimposed signal, and
detecting the resulting superimposed signal, and
determining a first part of the DUT-signal corresponding to the first signal part by means of the first code and determining a second part of the DUT-signal corresponding to the second signal part by means of the second code.

2. The method of claim 1, further comprising the steps of:
additionally splitting the optical signals into a third signal part having an initial third polarization and a fourth signal part having an initial fourth polarization,
coding the third signal part using a third code and coding the fourth signal part using a fourth code,
providing the first, the second, the third and the fourth coded signal parts to the DUT,
detecting a DUT signal coming from the DUT in response to the coded signal parts and
determining a first part of the DUT-signal corresponding to the first signal part by means of the first code and determining a second part of the DUT-signal corresponding to the second signal by means of the second code and determining a third part of the DUT-signal corresponding to the third signal part by means of the third code and determining a fourth part of the DUT-signal corresponding to the fourth signal part by means of the fourth code.

3. The method of claim 1, comprising at least one of the features:
the step of coding includes at least one of a group comprising:
any manipulation of the signal parts to unambiguously identify each signal part,
intensity modulating at least one of the signal parts,
using a binary code for at least one of the signal parts;
at least one of the applied first, second, third, and forth polarizations is orthogonal with respect to each of the other polarizations;
at least one of the applied codes is orthogonal with respect to each of the other codes;
the step of determining the parts of the DUT-signal comprises a step of multiplying the DUT-signal with each code.

4.-7. (canceled)

8. The method of claim 1, further comprising the steps of:
splitting the resulting superimposed signal into two, preferably orthogonal, parts and detecting each part separately.

9. The method of claim 1, further comprising the steps of:
providing the reference signal with a delay and with a reference code, and
identifying the reference signal by multiplying the reference signal with the reference code.

10. The method of claim 9, wherein the reference code fulfils the following conditions: the product of the reference code with the first code is orthogonal with the product of the reference code with the second code, the first code and the reference code are non-orthogonal and the second code and the reference code are non-orthogonal, and

11. An apparatus for polarization dependent analyzing an optical signal transmitted through a DUT, comprising:
a first coupler adapted for providing a first part of the optical signal to a measurement arm of an interferometer, and for providing a second part of the optical signal as a reference signal to a reference arm, and
a first beam splitter adapted splitting the first part of the optical signal into a first signal part having an initial first polarization and a second signal part having an initial second polarization,
a first modulator adapted coding the first signal part using a first code,
a second modulators adapted coding the second signal part using a second code,
a coupler connected to the modulators adapted for reuniting both coded signal parts and providing both coded signal parts to the DUT,
a second couplers adapted for superimposing a DUT-signal coming from the DUT in response to the coded signal parts with the reference signal of the interferometer to provide a resulting superimposed signals to the detector.
a detector adapted for detecting the resulting superimposed signal,
a first correlator adapted for determining a first signal part of the DUT-signal corresponding to the first signal part by means of the first code, and
a second correlator adapted for determining a second part of the DUT-signal corresponding to the second signal part by means of the second code.

12. The apparatus of claim 11,
wherein the first beam splitter is designed to additionally split the optical signal into a third signal part having an initial third polarization and a fourth signal part having an initial fourth polarization,
and further comprising:
a third modulator adapted for coding the third signal part using a third code,
a fourth modulator adapted for coding the fourth signal part using a fourth code,
wherein the coupler is additionally connected to the third and the fourth modulator and is designed to reunite the coded signal parts and to provide the first, the second, the third and the fourth coded signal parts to the DUT,
a third correlator adapted for determining a third signal part of the DUT-signal corresponding to the third signal parts by means of the third code, and
a fourth correlator adapted for determining a fourth part of the DUT-signal corresponding to the fourth signal part by means of the fourth code.

13. The apparatus of claim 11, comprising at least one of the features:
coding comprises any manipulation of the signal parts to unambiguously identify each signal part;
at least one of the applied first, second, third, and forth polarizations is orthogonal with respect to each of the other polarizations;
at least one of the applied codes is orthogonal with respect to each of the other codes;
at least one of the modulators is adapted to at least one of the following group including:
intensity modulating at least one of the signal parts to code the signal parts,
using a binary code for at least one of the signal parts to code the signal parts;
at least one of the correlators is adapted to determine the parts of the DUT-signal by multiplying the DUT-signal with each code.

14.-18. (canceled)

19. The apparatus of claim 11, further comprising:
a second beam splitter adapted for splitting the resulting superimposed signal into two, preferably orthogonal, parts, and
a second detector adapted to detect each part separately.

20. The apparatus of claim 11, further comprising:
a delay line in the reference arm adapted for providing the reference signal with a delay and with a reference code, and
a fifth correlator adapted for identifying the reference signal by multiplying the reference signal with the reference code.

21. The apparatus of claim 11, further comprising:
a fifth modulator adapted to apply the reference code to the reference signal which fulfills the following conditions: the product of the reference code with the first code is orthogonal with the product of the reference code with the second code, the first code and the reference code are non-orthogonal and the second code and the reference code are non-orthogonal.
